(19) United States
(12) Patent Application Publication
(10) Pub. No.: US 2004/0040842 A1
(43) Pub. Date: Mar. 4, 2004

(54) Electrochemical analytical apparatus and method of using the same

(76) Inventors: Mackenzie E. King, Southbury, CT (US); John W. Staples, Buffalo Grove, IL (US); Joseph W. Evans, Oak Park, IL (US); Daniel O. Clark, Pleasanton, CA (US); Peter M. Robertson, Winkel (CH); Thomas B. Chatterton, Cedar Park, TX (US); Thomas Hartford, Zion, IL (US)

Correspondence Address: ATMI, INC., 7 COMMERCE DRIVE, DANBURY, CT, 06810, US

(21) Appl. No.: 10/233,943

(22) Filed: Sep. 3, 2002

(51) Int. Cl. G01N 27/26

(52) U.S. Cl. 204/408; 204/416; 204/434

(57) ABSTRACT

The present invention relates to an electrochemical analytical apparatus for analyzing an electrochemical deposition solution, comprising a testing electrode, and a temperature detector attached thereto for monitoring temperature of said testing electrode. Preferably, such temperature detector is a resistance temperature detector.

### BACKGROUND OF THE INVENTION

1. Field of Invention

The present invention relates to an analytical apparatus for analyzing electrochemical deposition solutions.

2. Related Art

One technique used extensively for plating metal onto a substrate is by electrochemical deposition process, which uses an electrochemical deposition solution (hereinafter “ECD solution”) containing metal components in ionic form.

The metallurgical properties of the metal deposit depend on the composition of the ECD solution. For example, the concentration of metal ions in the ECD solution affects the plating rate and the plating potential. Moreover, most ECD solutions contain one or more organic additives, which affect the plating performance of the ECD solutions, by improving leveling and throwing power. Throwing power refers to the ability to provide uniform plating in through holes for interconnections as well as on the top surface of multilayer printed circuit boards. Therefore, the concentration of organic additives in the ECD solutions are crucial in optimizing characteristics or properties of plated metallurgy, such as ductility, tensile strength, and solderability. In order to ensure consistent deposition of metal films, it is necessary to accurately determine the concentration of the metal ions and the organic additives in the ECD solution throughout the metal plating process, so as to maintain the concentration of such metal ions and organic additives within a specified range.

Various analytical tools have been designed in the past for monitoring compositions of ECD solutions. However, none of the conventional ECD analytical tools provides temperature monitoring and/or controlling mechanism for reducing temperature fluctuations during the composition analysis of the ECD solutions.

Such temperature fluctuations affect the measurement of component concentrations in the ECD solutions. For example, the determination of organic additive concentration, based on a standard addition method without temperature control, results in an error rate of 8%, when the temperature fluctuation is about ±3° C.

It is therefore an object of the present invention to provide precise temperature control during the analysis process of the ECD solutions, by using an electrochemical analytical apparatus with temperature management system for monitoring and/or controlling the measurement temperature during the ECD analysis.

Moreover, most commercially available ECD analytical tools use rotating disk electrodes (RDEs) as testing electrodes, which provide a high flux of ECD solution towards the electrode surface and result in stronger analytical signals (e.g., plating current or plating potential). Such RDEs rotate at an average rotating speed above 1000 rpm, and are therefore vulnerable to mechanical breakdowns.

It is therefore another object of the present invention to provide an electrochemical analytical apparatus comprising RDEs of enhanced mechanical strength and durability, which can be used for analyzing ECD solutions over an extended period of time so as to increase the reproducibility and reliability of the analytical data.

It is a further object of the present invention to provide an electrochemical analytical apparatus designed and constructed to minimize cross-contamination between various analytes during different measurement cycles.

Other objects and advantages will be more fully apparent from the ensuring disclosure and appended claims.

### SUMMARY OF THE INVENTION

The present invention in one aspect relates to an electrochemical analytical apparatus for analyzing an electrochemical deposition solution, comprising a testing electrode, and a temperature detector attached thereto for monitoring temperature of the testing electrode.

The present invention in another aspect relates to an electrochemical analytical apparatus for analyzing an electrochemical deposition solution, comprising a rotating disk electrode, having at least one mercury contact switch for establishing electrical connection between such rotating disk electrode and other stationary components of the electrochemical analytical apparatus.

The present invention in a further aspect relates to an electrochemical analytical apparatus for analyzing an electrochemical deposition solution, comprising multiple analytical cells, wherein each analytical cell is used for analyzing one analyte contained in the electrochemical deposition solution.

The present invention in a still further aspect relates to an electrochemical analytical apparatus for analyzing an electrochemical deposition solution, comprising:

(a) an analytical cell comprising a liquid inlet, a sample solution holder, and a liquid outlet, wherein a sample electrochemical deposition solution is flew into such analytical cell via the liquid inlet and out of such analytical cell via the liquid outlet, and the sample solution holder comprises a front wall and a back wall placed in close proximity so as to hold the sample electrochemical deposition solution in form of a liquid film;

(b) an irradiation light source for irradiating light onto the liquid film held by the sample solution holder;

(c) a light detector for detecting light transmitted or reflected by the liquid film; and

(d) a computational device connected with the light detector, for determining concentration of at least one target species contained by the sample electrochemical deposition solution, based on absorbance of the irradiated light by the sample electrochemical deposition solution.

Additional aspects, features and embodiments of the invention will be more fully apparent from the ensuing disclosure and appended claims.

### BRIEF DESCRIPTION OF THE DRAWINGS

FIG. 1 is a perspective view of a testing electrode with a temperature detector and a heating element attached thereon, and a microcontroller that receives signal from the temperature detector and uses the heating element to adjust the temperature of the testing electrode, based on such signal.

FIG. 2 is a perspective view of a testing electrode with a resistance temperature detector (“RTD”) attached thereon, while the RTD is connected to a remote computer, which corrects the concentration measurements based on the temperature measured by the RTD to eliminate the effect of temperature fluctuations.

FIG. 3A is a perspective view of a rotating disk electrode comprising a single rotating disk with a temperature detector of bifilar winding attached thereon.

FIG. 3B shows a cross-sectional view of the rotating disk electrode of FIG. 3A from line I-I.

FIG. 4A is a perspective view of a rotating disk electrode comprising two electrically connected rotating disks, with a temperature detector of bifilar winding attached to one of such rotating disks.

FIG. 4B shows a cross-sectional view of the rotating disk electrode of FIG. 4A from line II-II.

FIG. 5A is a perspective view of a rotating disk electrode assembly comprising multiple electrically isolated rotating disks, with a temperature detector of bifilar winding attached to one of such rotating disks.

FIG. 5B shows a cross-sectional view of the rotating disk electrode of FIG. 5A from line III-III.

FIG. 6 is a perspective view of a prior art rotating disk electrode with a conventional contact brush for electric connection thereto.

FIG. 7A is a perspective view of a rotating disk electrode according to one embodiment of the present invention, having a mercury contact switch for electric connection thereto.

FIG. 7B is a perspective view of a rotating disk electrode according to another embodiment of the present invention, having a self-sealing mercury contact switch for electric connection thereto.

FIG. 8A is a top view of an electrochemical solution analyzer with two measuring cells separated by a built-in dividing wall.

FIG. 8B is a cross-sectional view of the electrochemical solution analyzer of FIG. 8A from line IV-IV.

FIG. 9 is a perspective view of an Infra-Red (IR) light absorption-based electrochemical solution analyzer, which measures the absorption of IR light by a thin film of the ECD sample solution for determining concentration of organic additives therein.

### DETAILED DESCRIPTION OF THE INVENTION, AND PREFERRED EMBODIMENTS THEREOF

In order to reduce temperature fluctuations during the measurement of electrochemical deposition solutions, so as to enhance the reliability and reproducibility of the measurement results, the present invention provides an electrochemical analytical apparatus with a temperature management system, which limits the temperature fluctuations to below ±2° C.

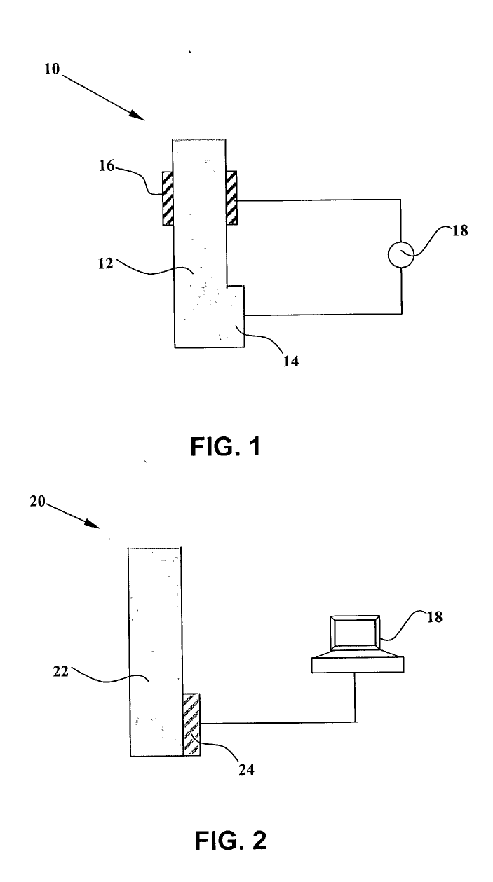

In one embodiment of the present invention, the electrochemical analytical apparatus comprises a testing electrode that has a temperature detector attached thereto. In FIG. 1, the testing electrode 10 comprises a platinum electrode tip 12, and a platinum temperature detector 14 integrated with the platinum electrode tip 12. It is preferred that the platinum electrode tip 12 and the platinum temperature detector 14 are made of the same piece of platinum metal. Alternatively, the platinum temperature detector 14 and the platinum electrode tip 12 can be manufactured separately and subsequently integrated together, via welding, adhering, or other form of binding. The temperature at the surface of the electrode 10 is measured directly by the temperature detector 14, due to the electrical and thermal connection between the platinum electrode tip 12 and the platinum temperature detector 14.

Moreover, the testing electrode 10 of FIG. 1 further comprises a heating element 16, which is controlled by a microcontroller 18, for adjusting the temperature of the platinum electrode tip 12. A microcontroller is an inexpensive single-chip computer, which is capable of storing and running a program, and the PIC® microcontrollers manufactured by Microchip Technology (Chandler, Ariz.) are preferably employed herein for the purpose of controlling the heating element 16 of the present invention. Specifically, the microcontroller is connected with the platinum temperature detector 14, so as to receive temperature measurement results therefrom and to adjust the temperature of the platinum electrode tip 12 through the heating element 16, based on such temperature measurement results.

In another embodiment of the present invention, as shown in FIG. 2, a testing electrode 20 comprises a metal electrode tip 22, and a resistance temperature detector (“RTD”) 24 integrated therewith. The temperature detector 24 is communicatively connected with a computational device 18, so as to send temperature measurement results to such computational device 18. The computation device 18 then mathematically corrects the concentration measurements, based on the electrode temperature measured by the RTD, so as to eliminate the effect of temperature fluctuations on the concentration measurements.

The operating current and voltage of the temperature detector in the present invention float with those of the testing electrode. In such manner, there is not interference with the operating of the electrode current.

In FIGS. 1 and 2, both temperature detectors are electrically and thermally connected to the testing electrodes. Alternatively, the temperature detectors may be integrated with the testing electrodes through bifilar winding, in which the temperature detectors are electrically insulated from but are thermally connected to the testing electrodes by an inert, electrically non-conductive, and thermally conductive material, such as highly directionally oriented graphite, glass, ceramic, etc. The bifilar winding, formed preferably by platinum wire spirals around the testing electrode, reduces the effective enclosed area of the coil, minimizes magnetic (or noise) pickup, and therefore enhances the signal-to-noise ratio.

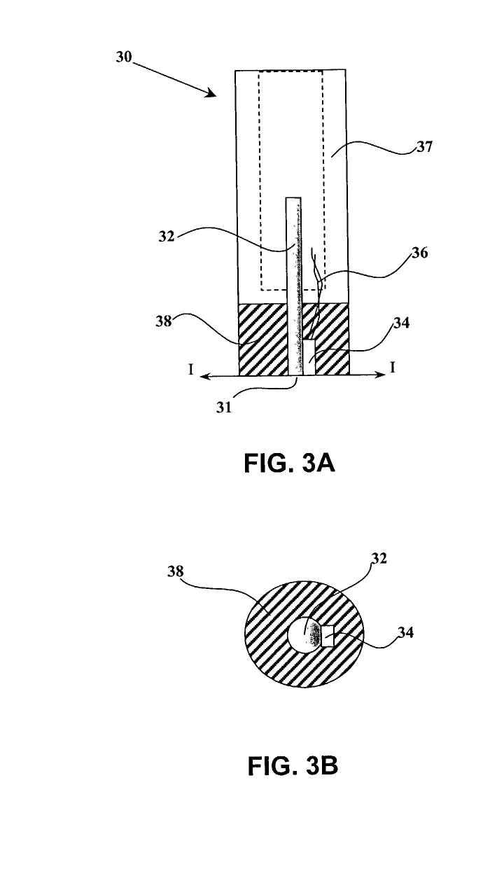

FIG. 3A shows a perspective view of a rotating disk electrode 30 with a single rotating disk 32 made of platinum, to which a temperature detector 34 with bifilar winding 36 is attached. Specifically, the temperature detector 34 is attached to the rotating disk 32 by epoxy potting material 38, and the rotating disk 32 is structurally integrated with other parts of the rotating disk electrode 30 by a mechanically stable and inert material 37. The material 37 preferably is a fluorocarbon-based polymer, more preferably is polychlorotrifluoroethylene (“PCTFE”), which is commonly referred to as Kel-F®.

FIG. 3B shows a cross-sectional view of the electrode surface 31 of the rotating disk electrode 30, from the line I-1.

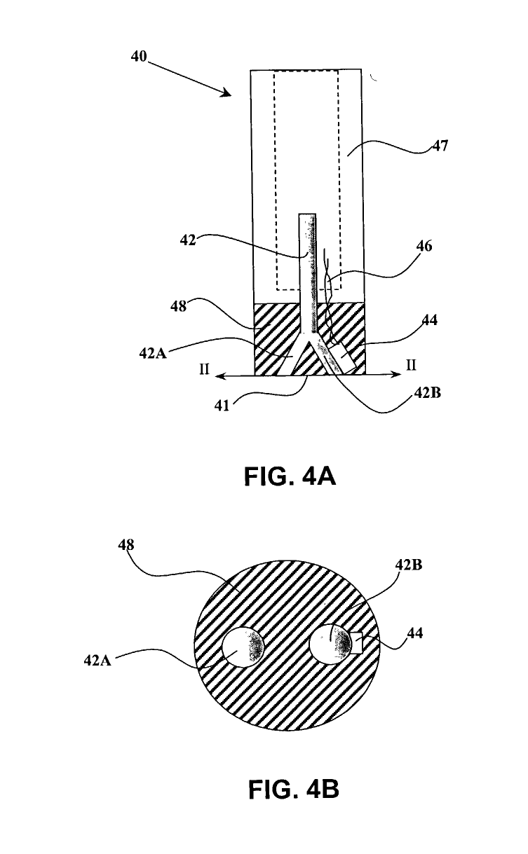

FIG. 4A shows a perspective view of a rotating disk electrode 40 with two rotating disks 42A and 42B, which are electrically connected together by the connector 42. The two rotating disks 42A and 42B are both off center in relating to the rotating disk electrode 40, providing better laminar flow of the electrochemical deposition solution. A temperature detector 44 is attached to one rotating disk 42B, with bifilar winding 46. The temperature detector 44 is likewise attached to the rotating disk 42B by epoxy potting material 48, and the rotating disks 42A, 42B, and their connector 42 are structurally integrated with other parts of the rotating disk electrode 40 by a mechanically stable and inert material 47.

FIG. 4B shows a cross-sectional view of the electrode surface 41 of the rotating disk electrode 40, from the line II-II.

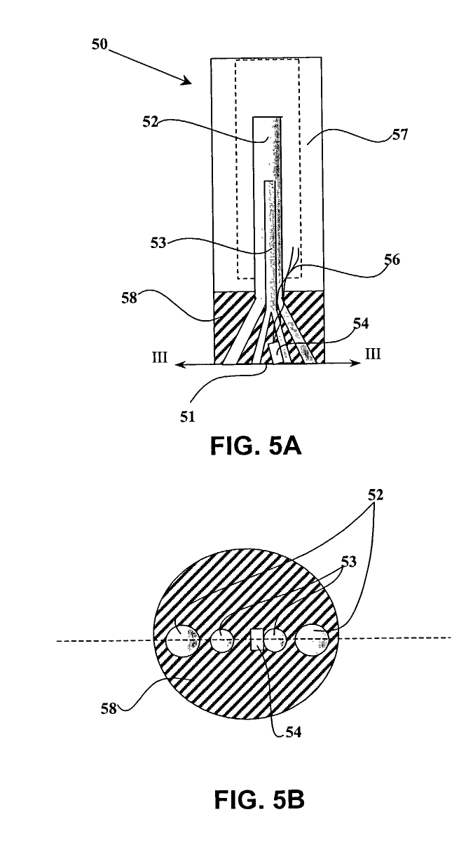

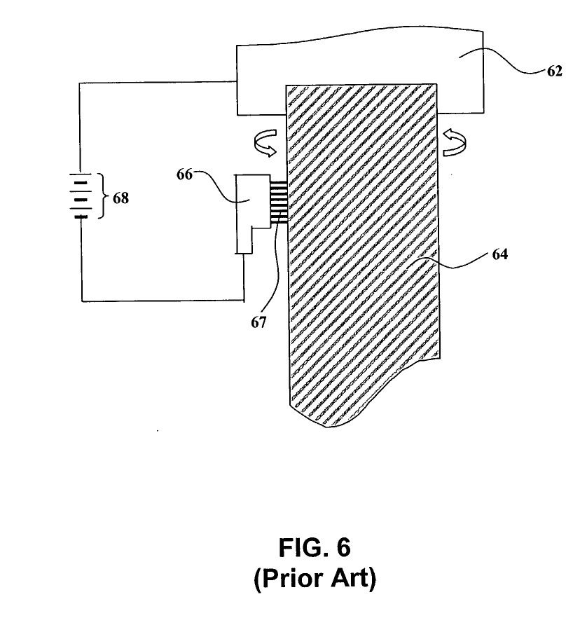

FIG. 5A shows a perspective view of a rotating disk electrode 50 with multiple rotating disks 52 and 53, which are electrically isolated to each other. A temperature detector 54 is attached to one rotating disk 53, with bifilar winding 56. The temperature detector 54 is likewise attached to the rotating disk 53 by epoxy potting material 58, and the rotating disks 52 and 53 are structurally integrated with other parts of the rotating disk electrode 50 by a mechanically stable and inert material 57.

FIG. 5B shows a cross-sectional view of the electrode surface 51 of the rotating disk electrode 50, from the line III-III.

The rotating disk electrode 50 of FIG. 3 provides a device analogous to the rotating ring disk electrode, and can therefore be used for kinetic studies in place of the conventional rotating ring disk electrode.

The rotating disk electrodes as described hereinabove provides an intimate chemical bond between the epoxy potting material, the metal rotating disk, and the Kel-F® material. Such chemical bond enhances the electrode seal and avoids seepage of electrolytes into the rotating disk electrode, which is particularly important for maintaining a constant electrode tip surface area and a constant current density.

The electrochemical analytical apparatus of the present invention may use other temperature monitoring/controlling mechanisms than the temperature detector as described hereinabove, to achieve improved temperature control of the analytical process.

For example, such electrochemical analytical apparatus may be placed in a chamber equipped with adjustable heating elements, so that operating temperature within such chamber is strictly controlled within a predetermined range, with limited fluctuations.

Alternatively, metal blocks or metal tubes connected to an external heating element or thermo-controller can be used in analytical cells of such electrochemical analytical apparatus, for conveying thermal energy thereto so as to keep the temperature of the analytical cells within a predetermined range, with limited fluctuations.

Alternatively, the metal electrode of common ionic species can be directly connected to an external heating element or thermo-controller, and used concurrently as a heating element to supply thermal energy to the electrochemical deposition solutions analyzed by such electrochemical analytical apparatus, for the purpose of keeping the temperature of the analytical apparatus within a predetermined range, with limited fluctuations.

It is clear from experimentation that the measurement results obtained by electrochemical analytical apparatuses without any temperature control mechanism have an average error rate of 8%, due to temperature fluctuations of about ±3° C. That means that for each 1.5° C. fluctuation in temperature, there is a measurement error equivalent to 2 ml of organic species per liter of sample electrochemical deposition solution being measured.

By providing an electrochemical analytical apparatus with temperature management system, the present invention intends to limit temperature fluctuations within ±2° C., more preferably within ±1° C., and most preferably ±0.5° C., so as to reduced the error rate caused by such temperature fluctuations.

Conventional electrochemical analytical apparatus comprising rotating disk electrodes employs contact brushes to electrically connect the continuously rotating electrode with other stationary components of said analytical apparatus, by passing electrical current from the stationary components to the rotating disk electrode through the contact brushes.

FIG. 6 shows a contact brush 67 used in conventional electrochemical analytical apparatus. The shaft 64 of a rotating disk electrode is driven by a rotatory actuator 62, so as to engage in a continuously rotating motion. The contact brush 67 is fixed at one end to a stationary component 66 of the electrochemical analytical apparatus, while the other end of such contact brush 67 directly contacts the rotating shaft 64, so as to form an electrical connection therewith without hindering the rotating of the shaft 64. Electrically current can be passed to the rotating shaft 64, from an electrical source 68 through the stationary component 66 and the contact brush 67.

However, since most of the rotating disk electrodes used for electrochemical analysis purposes are operated at very high rotating speeds, usually above 1000 rpm, said contact brush becomes shorter and shorter during operation, due to constant abrasion between the contact brush and the rotating disk electrode. The electrical connection established by the contact brush therefore becomes unreliable after an extended period of time and is vulnerable to disconnection, which forces the electrochemical analysis process to be stopped in order to allow replacement of the shortened contact brush. The analytical data so obtained is therefore irreproducible, and does not satisfy the strict reproducibility requirements generally imposed by the semiconductor industry.

The present invention therefore provides a novel rotating disk electrode assembly that is electrically and mechanically robust for continuously operation at high rotating speed.

Specifically, such rotating disk electrode assembly comprises a mercury contact switch, in place of the conventional contact brush, for establishing electrical connection between the rotating disk electrode and other stationary components of the analytical apparatus.

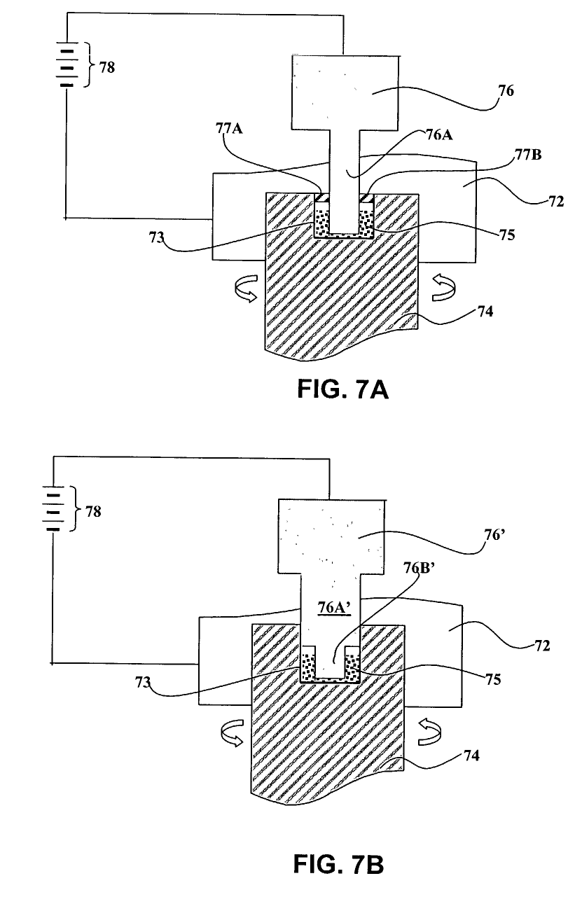

FIG. 7A shows one type of mercury contact switch useful for purpose of practicing the present invention, according to one preferred embodiment. The rotating shaft 74 of a rotating disk electrode is driven by a rotatory actuator 72, so as to engage in a continuously rotating motion. A stationary component 76 of the electrochemical analytical apparatus comprises a contact extrusion 76A, which is inserted into a recess 73 on the rotating shaft 74 of the rotating disk electrode. The contact extrusion 76A does not directly contact the recess 73 or any other part of the rotating shaft 74. Instead, the recess 73 contains a conductive metal liquid 75, preferably mercury, which establishes an indirect electrical connection between the stationary component 76 and the rotating shaft 74, so that electrical current from an electrical source 78 can be passed to the rotating shaft 74, through the stationary component 76, its contact extrusion 76A, and the conductive metal liquid 75 that is in contact with the rotating shaft 74. Since the contact extrusion 76A of FIG. 7A does not directly contact the recess 73 and therefore does not provide any sealing therefor, sealing caps 77A and 77B are provided herein, for the purpose of sealing the recess 73 and preventing the conductive metal liquid 75 from spilling or contaminating other part of the electrochemical analytical apparatus.

Alternatively, the stationary component may comprise a contact extrusion that functions concurrently as a sealing for the recess on the rotating shaft, therefore avoiding use of separate sealing caps. FIG. 7B shows a stationary component 76′ that comprises a contact shaft 76A′, which directly contacts the recess 73 peripherally, so as to seal the recess 73 and to prevent escape of the conductive metal liquid 75 therefrom. The contact shaft 76A′ supports a contact extrusion 76B′, which dips into the conductive metal liquid 75 for establishing an electrical connection between the stationary component 76′ and the rotating shaft 74.

The contact shaft 76A′ may be coated with an abrasion-resistant material, such as ceramic, to provide a tight sealing that is not subject to leakage, even after extended period of operation. The use of ceramic coating effectively reduces particle formation and allows the rotating assembly to rotate reliably without hinderage for extended period of time in harsh and corrosive environments.

Although the above description only shows one electrical connection established by a mercury contact switch between the rotating disk electrode and a stationary component, in general practice, the rotating disk electrode assembly comprises at least two rotating connections, one for the rotating disk electrode, and the other for the temperature detector as mentioned hereinabove. More preferably, the rotating disk electrode assembly comprises three rotating connections, one for the rotating disk electrode, and the other two for both ends of a resistance temperature detector (“RTD”).

Another inventive aspect of the present invention involves use of separate analytical cells for analysis of different analytes, so as to avoid cross-contamination of different analytes during different analytical cycles. For example, if the electrochemical analytical apparatus is used to analyze n analytes in a sample electrochemical deposition solution (“ECD solution”), such analytical tool comprises n analytical cells, each for analysis of one analyte, so as to conduct simultaneous analysis of the analytes free of the risk of cross-contamination.

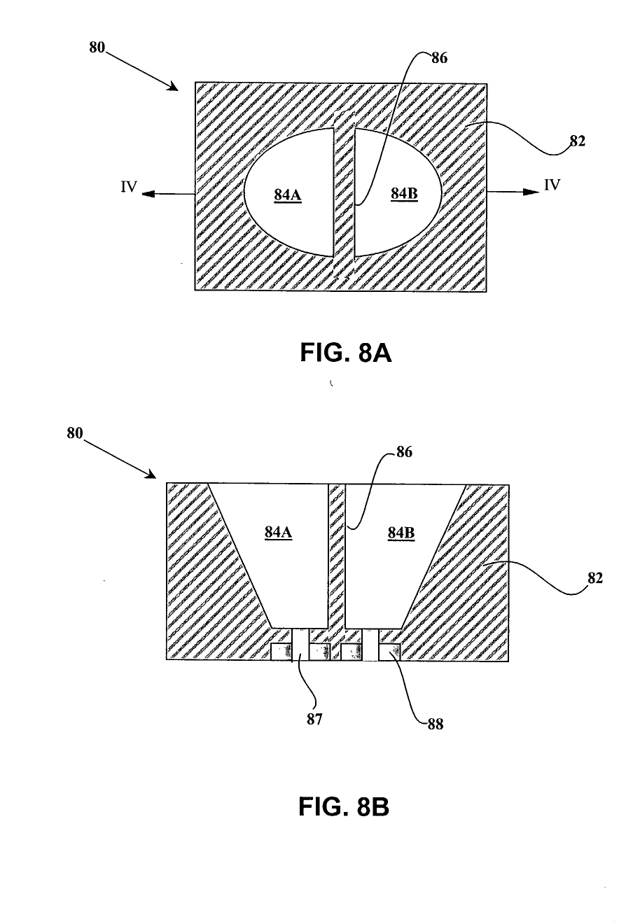

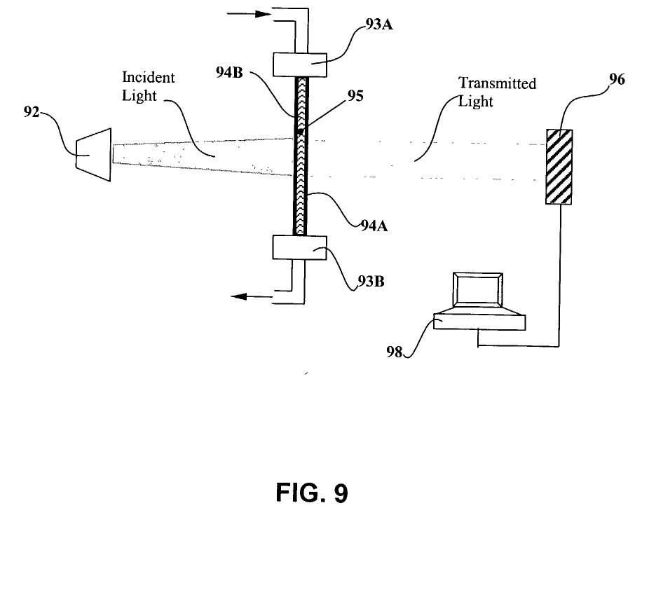

For example, FIG. 8A shows a cross-sectional view of an illustrative electrochemical analytical apparatus 80 used for analyzing two organic analytes (for example, accelerator and leveler) in an ECD solution. The electrochemical analytical apparatus 80 comprises an oval cavity bounded by peripheral walls 82, wherein such oval cavity is divided into a first analytical cell 84A and a second analytical cell 84B, by a dividing wall 86. Each analytical cell may comprise a testing electrode, a reference electrode, and a current source electrode for independent analysis of one analyte contained by the ECD solution. Moreover, each analytical cell may comprise a temperature control element 88, which can be a metal block (e.g., a copper block), for adjusting the operating temperature of such analytical cell, as shown in FIG. 8B. From draining holes 87, the sample ECD solution can be drained after each analytical cycle.

The peripheral walls 82 and the dividing wall 86 can be formed of a polymeric material, preferably polyolefin, and more preferably a 4-methylpentene-1 based polyolefin, commercially available as TPX® from Mitsui & Co. Ltd., Japan.

By using a separate cell for each analyte, the cross-contamination problem persistent in the conventional designs of electrochemical analytical apparatuses can be effectively solved. Moreover, the electrochemical analytical apparatus of the present invention, having multiple analytical cells, may be used to simultaneously carry out multiple analytical cycles for multiple analytes.

A further inventive aspect of the present invention relates to use of a light sensitive detector for detecting light absorbance of an ECD sample solution and determining composition of such ECD sample solution, based on characteristic absorbance of various analytes in the ECD solution.

Specifically, an electrochemical analytical apparatus according to one embodiment of the present invention comprising an analytical cell with a liquid inlet manifold 93A, a sample solution holder 94, and a liquid outlet manifold 93B. The sample solution holder 94 receives the ECD sample solution from the liquid inlet manifold 93A and discharges such into the liquid outlet manifold 93B, while such sample solution holder has a front wall 94A and a back wall 94B in close proximity to each other, so as to hold the ECD sample solution in form of a sufficiently thin liquid film 95. An irradiation light source 92 is provided for irradiating light onto the liquid thin film 95. The irradiating light includes, but is not limited to, infrared light, ultraviolet light, visible light, etc. Such irradiating light preferably is infrared (IR) light. A photodiode 96 is provided for detecting light transmitted or reflected by the liquid thin film 95, and preferably the photodiode 96 is IR-sensitive. The photodiode 96 is connected to a computational device 98, so that characteristic absorbance data of specific species in the ECD solution can be collected and sent to such computational device 98 for determining the concentration of specific species in the ECD solution. Such absorbance-based concentration determination is quick, and can be used for continuous and non-intrusive measurement of the ECD solution, while measured sample solution can still be used for electrodeposition.

Although the invention has been variously disclosed herein with reference to illustrative embodiments and features, it will be appreciated that the embodiments and features described hereinabove are not intended to limit the scope of the invention, and that other variations, modifications and other embodiments will suggest themselves to those of ordinary skill in the art. The invention therefore is to be broadly construed, consistent with the claims hereafter set forth.

What is claimed is:

1. An electrochemical analytical apparatus for analyzing an electrochemical deposition solution, comprising a testing electrode, and a temperature detector attached thereto for monitoring temperature of said testing electrode.

2. The electrochemical analytical apparatus of claim 1, wherein the temperature detector is in direct thermal connection with the testing electrode.

3. The electrochemical analytical apparatus of claim 1, wherein the temperature detector is in direct thermal and electrical connection with the testing electrode.

4. The electrochemical analytical apparatus of claim 1, wherein the testing electrode comprises a metal or metal alloy, and wherein the temperature detector comprises the same metal or metal alloy as that of the testing electrode.

5. The electrochemical analytical apparatus of claim 1, wherein the testing electrode and the temperature detector both comprise platinum or platinum alloy.

6. The electrochemical analytical apparatus of claim 1, wherein the testing electrode and the temperature detector are made of a single piece of metal so as to form an integral unit.

7. The electrochemical analytical apparatus of claim 1, wherein the temperature detector is separately manufactured and subsequently bonded onto the testing electrode.

8. The electrochemical analytical apparatus of claim 1, wherein the temperature detector monitors temperature at a surface of the testing electrode.

9. The electrochemical analytical apparatus of claim 1, further comprising a microcontroller connected with the temperature detector, and a heating element attached to the testing electrode, wherein the microcontroller controls temperature of the testing electrode through the heating element, based on temperature measurement obtained by the temperature detector.

10. The electrochemical analytical apparatus of claim 1, further comprises a computational device connected with the temperature detector, wherein said computational device receives temperature information from the temperature detector, and mathematically corrects analytical results generated by the electrochemical analytical apparatus, based on said temperature information.

11. The electrochemical analytical apparatus of claim 1, wherein operating current and voltage of said temperature detector float with those of the testing electrode.

12. The electrochemical analytical apparatus of claim 1, wherein the temperature detector is thermally connected to the testing electrode, but is electrically isolated therefrom by an inert, electrically non-conductive, and thermally conductive material.

13. The electrochemical analytical apparatus of claim 1, wherein the temperature detector comprises bifilar winding.

14. The electrochemical analytical apparatus of claim 1, wherein the testing electrode comprises a rotating disk electrode.

15. The electrochemical analytical apparatus of claim 14, wherein the rotating disk electrode comprises a single rotating disk.

16. The electrochemical analytical apparatus of claim 14, wherein the rotating disk electrode comprises multiple electrically connected rotating disks.

17. The electrochemical analytical apparatus of claim 16, wherein the rotating disk electrode comprises two off-center rotating disks that are electrically connected to each other via a connector.

18. The electrochemical analytical apparatus of claim 14, wherein the rotating disk electrode comprises multiple electrically isolated rotating disks.

19. The electrochemical analytical apparatus of claim 14, wherein the temperature detector comprises bifilar winding.

20. The electrochemical analytical apparatus of claim 14, wherein the temperature detector comprises at least one resistance temperature detector.

21. The electrochemical analytical apparatus of claim 1, wherein the testing electrode and the temperature detector are potted together by epoxy potting material to form a chemical bonding therebetween, so as to seal the testing electrode against electrolyte contained in the electrochemical deposition solution to be analyzed.

22. The electrochemical analytical apparatus of claim 1, disposed in a heated chamber that comprises heating elements for controlling temperature within said heated chamber within a predetermined range, so as to limit temperature fluctuations within said heated chamber to not more than ±2° C.

23. The electrochemical analytical apparatus of claim 22, wherein the temperature fluctuations within said heated chamber are limited to not more than ±1° C.

24. The electrochemical analytical apparatus of claim 22, wherein the temperature fluctuations within said heated chamber are limited to not more than ±0.5° C.

25. The electrochemical analytical apparatus of claim 1, further comprising at least one metal heat exchanger connected to an external thermal energy source for conveying external thermal energy to said electrochemical analytical apparatus, so as to control temperature of said electrochemical analytical apparatus within a predetermined range, and to limit temperature fluctuations within said electrochemical analytical apparatus to not more than ±2° C.

26. The electrochemical analytical apparatus of claim 25, wherein the temperature fluctuations within said electrochemical analytical apparatus are limited to not more than ±1° C.

27. The electrochemical analytical apparatus of claim 25, wherein the temperature fluctuations within said electrochemical analytical apparatus are limited to not more than ±0.5° C.

28. The electrochemical analytical apparatus of claim 1, wherein the testing electrode is directly connected to an external thermal energy source for conveying external thermal energy to said electrochemical analytical apparatus, so as to control temperature of said electrochemical analytical apparatus within a predetermined range, and to limit temperature fluctuations within said electrochemical analytical apparatus to not more than ±2° C.

29. The electrochemical analytical apparatus of claim 28, wherein the temperature fluctuations within said electrochemical analytical apparatus are limited to not more than ±1° C.

30. The electrochemical analytical apparatus of claim 28, wherein the temperature fluctuations within said electrochemical analytical apparatus are limited to not more than ±0.5° C.

31. An electrochemical analytical apparatus for analyzing an electrochemical deposition solution, comprising a rotating disk electrode, having at least one mercury contact switch for establishing electrical connection between said rotating disk electrode and other stationary components of said electrochemical analytical apparatus.

32. The electrochemical analytical apparatus of claim 31, further comprising a temperature detector attached to said rotating disk electrode, for monitoring temperature of the rotating disk electrode.

33. The electrochemical analytical apparatus of claim 32, comprising at least two mercury contact switches, one for providing electrical connection to the rotating disk electrode, and one for providing electrical connection to said temperature detector.

34. The electrochemical analytical apparatus of claim 32, wherein said temperature detector comprises a resistance temperature detector having two measurement ends, and wherein said analytical apparatus comprises at least three mercury contact switches, one for providing electrical connection to the rotating disk electrode, and the other two for providing electrical connection to the two measurement ends of the resistance temperature detector.

35. An electrochemical analytical apparatus for analyzing an electrochemical deposition solution, comprising multiple analytical cells, wherein each analytical cell is used for analyzing one analyte contained in said electrochemical deposition solution.

36. The electrochemical analytical apparatus of claim 35, wherein analyses of multiple different analytes, as contained in said electrochemical deposition solution, are conducted simultaneously in said multiple analytical cells.

37. The electrochemical analytical apparatus of claim 36, comprising two analytical cells, one for analyzing a first organic analyte contained by the electrochemical deposition solution, and the other for analyzing a second organic analyte contained thereby.

38. The electrochemical analytical apparatus of claim 37, wherein the first organic analyte is an accelerator, and wherein the second organic analyte is a leveler.

39. The electrochemical analytical apparatus of claim 35, wherein each analytical cell comprises a testing electrode, a reference electrode, and a current source electrode for analyzing one analyte contained in said electrochemical deposition solution.

40. The electrochemical analytical apparatus of claim 35, wherein each analytical cell comprises a temperature-controlling device for adjusting operating temperature within said analytical cell.

41. An electrochemical analytical apparatus for analyzing an electrochemical deposition solution, comprising:
(a) an analytical cell comprising a liquid inlet, a sample solution holder, and a liquid outlet, wherein a sample electrochemical deposition solution is flew into said analytical cell via the liquid inlet and out of said analytical cell via the liquid outlet, and said sample solution holder comprises a front wall and a back wall placed in close proximity so as to hold the sample electrochemical deposition solution in form of a liquid film;
(b) an irradiation light source for irradiating light onto the liquid film held by said sample solution holder;
(c) a light detector for detecting light transmitted or reflected by the liquid film; and
(d) a computational device connected with the light detector, for determining concentration of at least one target species contained by said sample electrochemical deposition solution, based on absorbance of the irradiated light by the sample electrochemical deposition solution.

42. The electrochemical analytical apparatus of claim 41, wherein the irradiated light is infrared light.

43. The electrochemical analytical apparatus of claim 42, wherein the light detector is infrared-sensitive.

44. The electrochemical analytic apparatus of claim 41, wherein the light detector is a photodiode.
